(19) United States
(12) Patent Application Publication
(10) Pub. No.: US 2005/0080901 A1
(43) Pub. Date: Apr. 14, 2005

(54) Method and apparatus for controlling access to multicast data streams

(76) Inventor: Scot A. Reader, Sherman Oaks, CA (US)

Correspondence Address: Scot A. Reader, Esq., 1320 PEARL STREET, SUITE 228, BOULDER, CO, 80302, US

(21) Appl. No.: 10/684,625

(22) Filed: Oct. 14, 2003

(51) Int. Cl. G06F 15/173

(52) U.S. Cl. 709/226

(57) ABSTRACT

A method and apparatus for authorizing multicast group membership based on network policies, such as machine and user identities. An end station communicates with a LAN switch over a LAN link. The LAN switch inhibits the end station from joining any multicast group before the end station or a user on the end station becomes authenticated. Once the end station or a user on the end station becomes authenticated, the LAN switch authorizes the end station to join one or more multicast groups in conformance with a multicast group authorization specified for the end station or the user. The LAN switch enforces the multicast group authorization attendant to “snooping” of IGMP membership reports received from the end station or processing of CGMP join messages received from a router.

### BACKGROUND OF INVENTION

This invention relates to multicasting in data communication networks, and more particularly to controlling end station access to multicast data streams within data communication networks.

Internet Protocol (IP) Multicast is a network layer (OSI Layer 3) technology for efficiently delivering data traffic from a single source host to multiple destination hosts. IP Multicast ensures efficient delivery at Layer 3 by replicating packets only at router branch points of a loop-free distribution tree between the source host and the destination hosts.

Data link layer (OSI Layer 2) technologies have been implemented to extend the efficiencies of IP Multicast to switched local area network (LAN) infrastructures between routers and destination hosts. The basic building block of switched LAN infrastructures is the LAN switch. The default behavior of LAN switches is to forward multicast traffic on switch ports without regard to whether the switch ports support an end station that is a destination host for the multicast. This default “flooding” behavior of LAN switches results in superfluous transmission of IP Multicast traffic in switched LAN infrastructures and prevents switched LAN infrastructures from capturing the efficiencies of IP Multicast. To limit this default “flooding” behavior, IP Multicast extension protocols, such as Internet Group Management Protocol (IGMP) Snooping and Cisco Group Management Protocol (CGMP), have been deployed on LAN switches. These protocols, in essence, enable LAN switches to learn which switch ports support which IP Multicast destination hosts and limit forwarding of IP Multicast traffic accordingly.

While known IP Multicast extension protocols have reduced superfluous transmission of IP Multicast traffic by LAN switches, these protocols have not limited transmission of IP Multicast traffic by LAN switches based on network policies. For example, in a switched LAN infrastructure running IGMP Snooping, a LAN-attached end station joins an IP Multicast data stream by sending an IGMP membership report to its neighboring router via the LAN switch to which the end station is attached. The report specifies a multicast group corresponding to the IP Multicast data stream to be joined. The LAN switch “snoops” the report and associates the group with the switch port on which the report arrived to enable forwarding of traffic addressed to the group on the switch port. However, the LAN switch does not render any threshold decision as to whether to allow the end station to receive traffic addressed to the group based on network policy, such as machine or user identity. Such authorizations are outside the scope of known IP Multicast extension protocols.

### SUMMARY OF THE INVENTION

The present invention, in a basic feature, provides a method and apparatus for controlling end station access to traffic addressed to a multicast group based on a network policy, such as machine or user identity.

In one aspect, an end station communicates with a LAN switch over a LAN link. The LAN switch inhibits the end station from receiving traffic in any multicast group before the end station or a user on the end station becomes authenticated. Once the end station or a user on the end station becomes authenticated, the LAN switch authorizes the end station to receive traffic in one or more multicast groups in conformance with a multicast group authorization specified for the end station or user. The multicast group authorization may be, for example, a list of permitted multicast groups for which the end station or user is authorized or a list of proscribed multicast groups for which the end station or user is not authorized.

In another aspect, the LAN switch enforces the multicast group authorization attendant to “snooping” of IGMP membership reports received from end stations. The LAN switch “snoops” a membership report originated by an end station and determines whether a multicast group specified in the membership report conforms to a multicast group authorization associated with the end station. If the multicast group does not conform to the multicast group authorization, the LAN switch inhibits the end station from joining the multicast group.

In another aspect, the LAN switch enforces the multicast group authorization attendant to processing of CGMP join messages received from a router. The LAN switch receives a join message regarding an end station and determines whether a multicast group specified in the message conforms to the multicast group authorization associated with the end station. If the multicast group does not conform to the multicast group authorization, the LAN switch inhibits the end station from receiving traffic addressed to the multicast group.

These and other aspects of the invention will be better understood by reference to the detailed description of the preferred embodiment taken in conjunction with the drawings briefly described below. Of course, the invention is defined by the claims.

### BRIEF DESCRIPTION OF THE DRAWINGS

FIG. 1 shows a data communication network in a preferred embodiment of the invention.

FIG. 2 shows a LAN switch within the network of FIG. 1.

FIG. 3 shows a switch manager within the LAN switch of FIG. 2.

FIG. 4 is a flow diagram describing an IGMP Snooping protocol operative on the LAN switch of FIG. 2 enhanced with an authorization check and integrated with an authentication function.

FIG. 5 is a flow diagram describing a CGMP protocol operative on the LAN switch of FIG. 2 enhanced with an authorization check and integrated with an authentication function.

### DETAILED DESCRIPTION OF THE PREFERRED EMBODIMENT

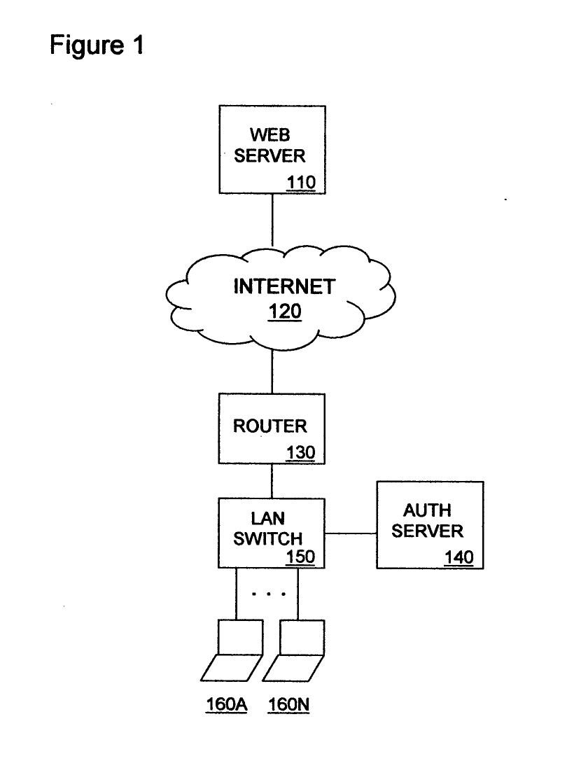

In FIG. 1, a data communication network is shown to include Web server 110, Internet 120, router 130, authentication server 140, LAN switch 150 and end stations 160A through 160N. Web server 110 is an IP Multicast-aware source host capable of delivering an IP Multicast data stream, such as Moving Picture Experts Group (MPEG) video, to destination hosts for the data stream, including one or more of end stations 160A through 160N. End stations 160A through 160N may include, for example, personal computers, workstations or personal data assistants (PDAs). En route to the one or more of end stations 160A though 160N, the IP Multicast data stream passes through Internet 120, router 130 and LAN switch 150.

Internet 120 includes a series of IP Multicast-aware routers serving as branch points of a distribution tree for efficiently delivering the IP Multicast data stream originated by Web server 110 to edge routers, including router 130, that are associated with destination hosts for the data stream. The distribution tree may be either a source-based tree or a core-based tree, and may be constructed and dynamically updated using, for example, Protocol Independent Multicast Dense Mode (PIM-DM) or PIM Sparse Mode (PIM-SM).

Router 130 is an IP Multicast-aware edge router interposed between Internet 120 and LAN switch 150. Router 130 delivers the IP Multicast data stream to ones of end systems 160A through 160N that are destination hosts for the data stream via LAN switch 150. Ones of end systems 160A through 160N become destination hosts for the data stream by registering with router 130. Particularly, the IP Multicast data stream corresponds to a multicast group. Ones of end systems 160A through 160N that wish to join the multicast group send to router 130 an IGMP membership report message identifying the multicast group. In response, router 130 arranges to forward to LAN switch 150, for relay to the ones of end systems 160A through 160N that are registered destination hosts in the multicast group, packets addressed to the multicast group.

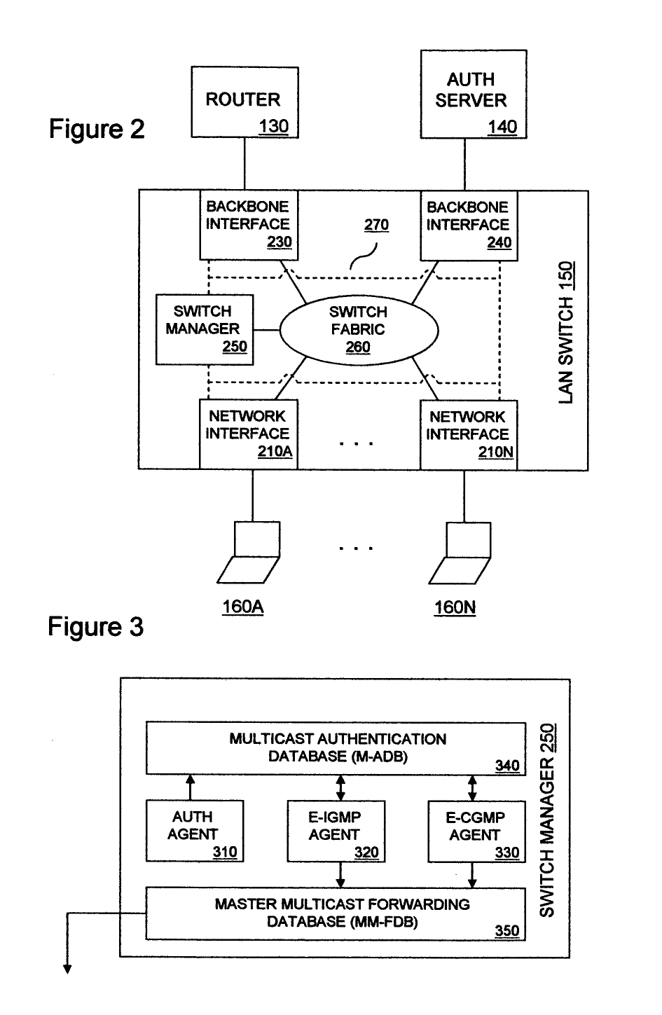

Turning to FIG. 2, LAN switch 150 is shown in more detail. LAN switch 150 includes network interfaces 210A through 210N for communicating with respective end stations 160A through 160N via respective LAN links. LAN links may be, for example, point-to-point 802.3 wired Ethernet or 802.11 wireless Ethernet connections. In the case where LAN links are wired links, network interfaces 210A through 210N communicate with their respective end stations 160A through 160N via a dedicated physical port on network interfaces 210A through 210N. In the case where LAN links are wireless links, network interfaces 210A through 210N communicate with their respective end stations 160A through 160N via a dedicated logical port on network interfaces 210A through 210N. Network interfaces 210A through 210N communicate with backbone interfaces 230, 240 and switch manager 250 via switch fabric 260. Backbone interfaces 230, 240 communicate with router 130 and authentication server 140, respectively, via one or more wired links, for example, 802.3 Ethernet links. Interfaces 210A through 210N, 230, 240 include physical layer transceivers, media access controllers and packet switching engines. Transceivers and media access controllers may be implemented using discrete logic, such as application specific integrated circuits (ASICs), whereas packet switching engines may be implemented using a combination of discrete logic and programmable logic, such as programmable network processors. Switch fabric 250 may be implemented using discrete logic, such as an ASIC, and may be any of various architectures, such as an N×N crossbar.

LAN switch 150 forwards known unicast data packets on designated switch ports using unicast forwarding databases. Switch manager 250, which may be implemented as a general purpose processor running various software programs, maintains a master unicast forwarding database (MU-FDB) having as entries media access control (MAC) addresses of nodes, for example, routers, servers and end stations, and associated switch ports through which the nodes are reachable. Switch manager 250 distributes the contents of the MU-FDB to interfaces 210A through 210N, 230, 240 in response to updates to the MU-FBD and thereby maintains slave unicast forwarding databases (SU-FBDs) on interfaces 210A through 210N, 230, 240. In unicast forwarding on LAN switch 150, the SU-FDB on the one of interfaces 210A through 210N, 230, 240 on whose external port a data packet is received, i.e., the ingress interface, is invoked to resolve a known unicast destination MAC address in the data packet to the one of switch ports on which the data packet is to be transmitted, and the data packet is transmitted on the resolved switch port. An exception arises if the resolved switch port is the switch port on which the data packet was received, i.e., the ingress switch port, in which case the data packet is not transmitted.

To maintain MU-FDB, the ingress one of interfaces 210A through 210N, 230, 240 “snoops” the source Media Access Control (MAC) address in data packets and notifies switch manager 250 of address/port associations that are not already in its SU-FDBs, and so need to be added to the MU-FDB. Such notification may be accomplished, for example, by transmitting to switch manager 250 a copy of such data packets along with an identifier of the ingress switch port.

LAN switch 150 forwards IP Multicast data packets on designated switch ports using multicast forwarding databases. In addition to “snooping” source MAC addresses, the ingress one of interfaces 210A through 210N, 230, 240 identifies broadcast/multicast packets by checking the broadcast/multicast bit in the destination MAC address of packets. If the bit is set, a further check is performed to identify whether a packet is an IP Multicast data packet. Turning to FIG. 3, switch manager 250 maintains a master multicast forwarding database (MM-FDB) 350. MM-FDB 350 has as entries multicast groups and associated switch ports through which destination hosts that are registered in the multicast groups are reachable. Switch manager 250 distributes the contents of MM-FDB 350 to interfaces 210A through 210N, 230, 240 in response to updates to MM-FDB 350 and thereby maintains slave multicast forwarding databases (SM-FDBs) on interfaces 210A through 210N, 230, 240. In IP Multicast forwarding on LAN switch 150, the SM-FDB on the ingress one of interfaces 210A through 210N, 230, 240 is invoked to resolve a multicast group address in an IP Multicast data packet to one or more switch ports, and the data packet is transmitted on all resolved switch ports, except the ingress switch port if it is one of the resolved switch ports.

Packets whose broadcast/multicast bit is set but which are not IP Multicast data packets are processed without resort to SM-FBD. For example, “true” broadcast packets and unknown unicast data packets are flooded on all switch ports, except the ingress switch port.

The contents of MU-FDB and MM-FDB 350 are distributed by switch manager 250 to interfaces 210A through 210N, 230, 240 on dedicated switch management bus 270 in order to minimize the load on switch fabric 260.

MM-FDB 350 is maintained by an IP Multicast extension protocol, such as IGMP Snooping or CGMP, enhanced to include an authorization check. To support these enhanced protocols, which are herein referred to as Enhanced IGMP (E-IGMP) Snooping and Enhanced CGMP (E-CGMP), respectively, switch manager 250 includes an E-IGMP agent 320 and an E-CGMP agent 330. E-IGMP agent 320 is a software program that supports E-IGMP Snooping, whereas E-CGMP agent 330 is a software program that supports E-CGMP. A network manager can select whether to activate E-IGMP Snooping or E-CGMP on LAN switch 150 through a network management software command directed to switch manager 250.

When E-IGMP Snooping is active, LAN switch 150 “snoops” IGMP packets to maintain MM-FDB 350. Particularly, the ingress one of interfaces 210A through 210N, 230, 240 identifies broadcast/multicast packets by checking the broadcast/multicast bit in the destination MAC address of packets. If the bit is set, a further check is performed to identify whether a packet is an IGMP membership report. If the packet is an IGMP membership report, the packet is transmitted to switch manager 250 with an identifier of the ingress switch port. On switch manager 250, E-IGMP agent 320 determines whether the switch port is authorized to join the multicast group identified in the report. Particularly, switch manager 250 maintains a multicast authorization database (M-ADB) 340 having as entries switch ports and associated multicast group addresses or address ranges for which the switch ports are authorized. Alternatively, M-ADB 340 may have as entries switch ports and associated multicast group addresses or address ranges for which the switch ports are not authorized. In either event, E-IGMP agent 320 determines from M-ADB 340 whether the multicast group address specified in the report is within the permitted or proscribed multicast group addresses or address ranges specified for the switch port. If there is conformance, that is, if the switch port is authorized to participate in the multicast group, E-IGMP agent 320 updates MM-FDB 350 to include the new multicast group/port association, and relays the packet to router 130 via backbone interface 240. If there is not conformance, that is, if the switch port is not authorized to participate in the multicast group, the packet is dropped without updating MM-FDB 350.

When E-CGMP is active, LAN switch 150 maintains MM-FDB 350 in conjunction with CGMP join messages received from router 130. In CGMP, instead of “snooping” IGMP membership reports en route from hosts 160A through 160N to router 130, LAN switch 150 waits for router 130 to return a CGMP join message. Particularly, router 130 is configured with an address of switch manager 250 and returns CGMP join messages to LAN switch 150 in response to IGMP membership reports. A CGMP join message uses the address of switch manager 250 as a destination address, and includes the MAC address of the one of hosts 160A through 160N that originated the corresponding IGMP membership report and the multicast group address of the multicast group referenced in the report. Backbone interface 230 transmits CGMP join messages received from router 130 to switch manager 250 on switch fabric 260. On switch manager 250, E-CGMP agent 330 invokes MU-FDB to resolve the MAC address of the one of hosts 160A through 160N that originated the report to its associated switch port. E-CGMP agent 330 then determines by reference to M-ADB 340 whether the resolved switch port is authorized to receive traffic in the multicast group identified in the message. If there is conformance, that is, if the switch port is authorized to participate in the multicast group, E-CGMP agent 330 updates MM-FDB 350 to include the new multicast group/port association. If there is not conformance, that is, if the switch port is not authorized to participate in the multicast group, the packet is dropped without updating MM-FDB 350.

M-ADB 340 is maintained in conjunction with an authentication function performed by authentication agent 310 and authentication server 140. When one of end stations 160A through 160N becomes active, its associated switch port on one of network interfaces 160A through 160N is in the unauthenticated state. Accordingly, the switch port drops all packets from the one of end stations 160A through 160N, except that authentication protocol packets are appended with an identifier of the ingress switch port and directed by the one of network interfaces 160A through 160N to authentication agent 310. The one of end stations 160A through 160N supplies machine or user credentials in one or more of the authentication protocol packets. The machine or user credentials may include, for example, a username, a password, a station name, a station identifier, a user certificate or a machine certificate. Authentication agent 310 relays the one or more packets including the machine or user credentials to authentication server 140 for verification. Authentication server 140 maintains machine or user records for verifying the machine or user credentials. If authentication server 140 is able to verify the machine or user credentials, authentication server 140 notifies authentication agent 310 that the one of end stations 160A through 160N or user thereon has been authenticated and the multicast groups for which the machine or user is authorized. Notification may be accomplished, for example, by transmitting to switch manager 250 a success packet with the identifier of the switch port associated with the end station that submitted the machine or user credentials and the permitted or proscribed multicast group addresses or address ranges. Authentication agent 310 updates M-ADB 340 to include the new port/group associations. Authentication agent 310 also notifies the one of network interfaces 210A through 210N to transition its associated switch port to the authenticated state, whereupon the switch port no longer indiscriminately drops non-authentication protocol packets from the one of hosts 160A through 160N. Naturally, if authentication server 140 is unable to verify the machine or user credentials, the switch port remains in the unauthenticated state and continues to drop all non-authentication protocol packets.

The IEEE Std. 802.1× protocol, wherein authentication server 140 is a Remote Authentication Dial In User Service (RADIUS) server, may be used to implement the authentication function. In that event, the permitted or proscribed multicast group addresses or address ranges may be conveyed from authentication server 140 to authentication agent 310 as a RADIUS attribute in an Extensible Authentication Protocol (EAP) success message.

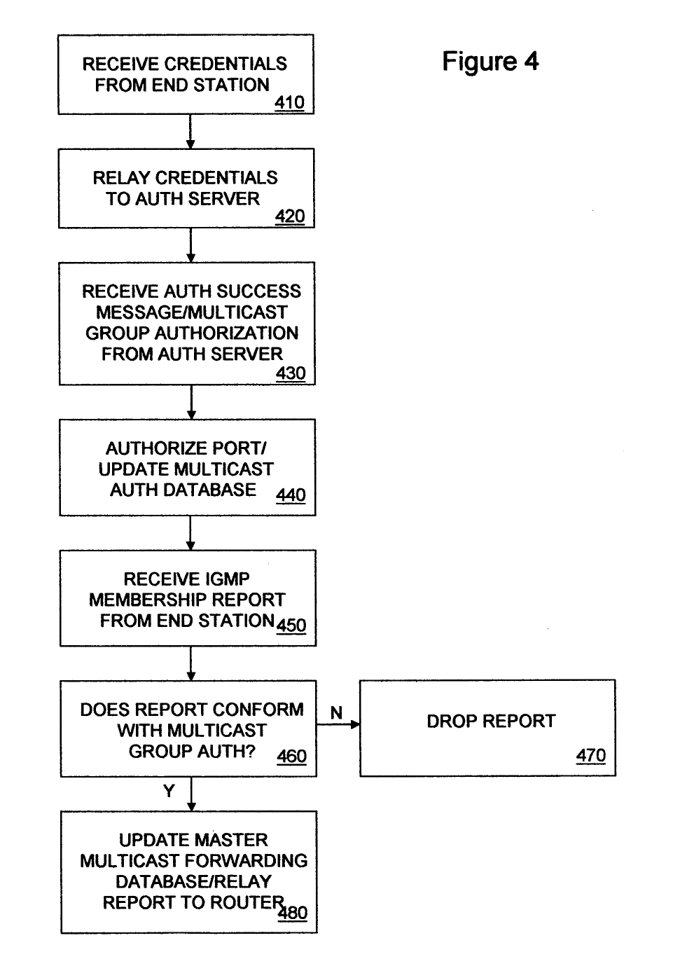

Referring now to FIG. 4, a flow diagram describes an IGMP Snooping protocol enhanced with an authorization check and integrated with an authentication function, from the perspective of LAN switch 150. LAN switch 150 receives credentials from one of end stations 160A through 160N (410) and relays them to authentication server 140 (420). Authentication server 140 verifies the credentials and responds to LAN switch 150 with an authentication success packet and the permitted or proscribed multicast groups for the end station (430). LAN switch 150 authorizes the port through which the end station communicates with LAN switch 150 and updates M-ADB 340 by adding the authorized multicast groups for the port (440). LAN switch 150 receives an IGMP membership report from the end station (450) and determines whether the end station is authorized to join the multicast group identified in the report by reference to the port/group association in M-ADB 340 (460). If the end station is not authorized, LAN switch 150 drops the report without updating MM-FDB 350 (470). If the host is authorized, LAN switch updates MM-FDB 350 to include the new group/port association and relays the report to router 130 (480).

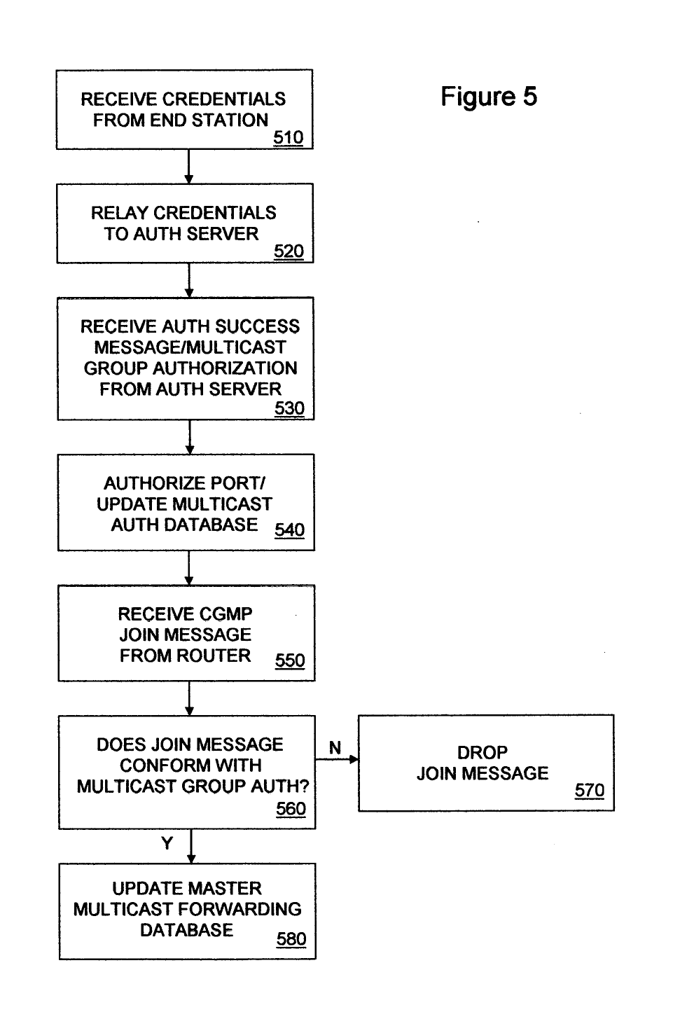

Referring finally to FIG. 5, a flow diagram describes a CGMP protocol enhanced with an authorization check and integrated with an authentication function, from the perspective of LAN switch 150. Steps 510-540 have counterparts in Steps 410-440 described above. In Step 550, however, LAN switch 150 receives a CGMP join message from router 130 regarding one of end stations 160A through 160N (550), resolves the end station's MAC address included in the join message to a port by resort to MU-FDB, and determines whether the end station is authorized to receive traffic in the multicast group identified in the join message by reference to the port/group association in M-ADB 340 (560). If the end station is not authorized, LAN switch 150 drops the join message without updating MM-FDB 350 (570). If the end station is authorized, LAN switch updates MM-FDB 350 to include the new group/port association (580).

It will be appreciated by those of ordinary skill in the art that the invention may be embodied in other specific forms without departing from the spirit or essential character hereof. The present description is therefore considered in all respects illustrative and not restrictive. The scope of the invention is indicated by the appended claims, and all changes that come within the meaning and range of equivalents thereof are intended to be embraced therein.

1-13. (canceled)

14. A method for controlling access to a multicast group in a data communication network, comprising:
receiving a CGMP join message from a router regarding an end station;
determining whether a multicast group in the CGMP join message conforms with a multicast group authorization associated with the end station; and
inhibiting the end station from receiving traffic addressed to the multicast group if the multicast group fails to conform with the multicast group authorization.

15. The method of claim 14, further comprising receiving the multicast group authorization in response to verification of a credential submitted by the end station.

16. The method of claim 15, wherein the credential is a user credential.

17. The method of claim 14, wherein the association of the multicast group authorization with the end station is inferred from an association of the multicast group authorization with a port through which the end station is known to access the network.

18. The method of claim 14, wherein the receiving, determining and inhibiting steps are performed on a LAN switch interposed between the end station and a router.

19. The method of claim 14, wherein the multicast group corresponds to an IP Multicast data stream.

20-23. (canceled)

24. A LAN switch, comprising:
a port for receiving a join message from a router regarding an end station; and
a switch manager for receiving the join message from the port, for determining whether a multicast group in the join message conforms with a multicast group authorization associated with the end station and for inhibiting the end station from receiving traffic addressed to the multicast group if the multicast group fails to conform with the multicast group authorization.

25. The switch of claim 24, wherein the switch manager receives the multicast group authorization from an authentication server in response to verification by the authentication server of a credential submitted by the end station.

26. The switch of claim 24, wherein the credential is a user credential.

27. The switch of claim 24, wherein the association of the multicast group authorization with the end station is inferred from an association of the multicast group authorization with a port through which the end station is known to access traffic from the router.

28. In a data communication network, a method performed on a second node communicating with a first node over a LAN link for controlling access of the first node to a multicast group, comprising the steps of:
receiving from the first node authentication information;
transmitting to an authentication server the authentication information;
receiving from the authentication server in response to the authentication information multicast group authorization information; and
storing in a database on the second node information based on the multicast group authorization information; then,
receiving from the first node a management packet having multicast group membership information;
comparing for conformance the multicast group membership information with the information stored in the database; and
authorizing transmission to the first node of data packets addressed to a multicast group in response to a finding of conformance.

29. The method of claim 28 wherein the authentication information comprises a user credential.

30. The method of claim 28 wherein the multicast group authorization information is indicative of one or more multicast groups.

31. The method of claim 28 further comprising the step of receiving from the authentication server in association with the multicast group authorization information an identifier of a port on the second node over which the first node and the second node communicate.

32. The method of claim 31 wherein the port is a physical port.

33. The method of claim 31 wherein the port is a logical port.

34. The method of claim 28 wherein the multicast group authorization information is a RADIUS attribute within an EAP success packet.

35. The method of claim 28 wherein the storing step further comprises adding an entry to the database associating a port on the second node over which the first node and the second node communicate with information indicative of one or more multicast groups.

36. The method of claim 28 wherein the management packet comprises an IGMP membership report.

37. The method of claim 28 wherein the data packets are IP Multicast data packets.

38. The method of claim 28 wherein the second node supports a plurality of IP Multicast extension protocols enhanced with respective authorization checks.

39. The method of claim 38 wherein the IP Multicast extension protocols comprise IGMP Snooping and CGMP.

40. In a data communication network, a method performed on a second node communicating with a first node over a LAN link for controlling access of the first node to a multicast group, comprising the steps of:
receiving from the first node authentication information;
transmitting to an authentication server the authentication information;
receiving from the authentication server in response to the authentication information multicast group authorization information; and
storing in a database on the second node information based on the multicast group authorization information; then,
receiving from a router a management packet having multicast group membership information regarding the first node;
comparing for conformance the multicast group membership information with the information stored in the database; and
authorizing transmission to the first node of data packets addressed to a multicast group in response to a finding of conformance.

41. The method of claim 40 wherein the multicast group authorization information is a RADIUS attribute within an EAP success packet.

42. The method of claim 40 wherein the storing step further comprises adding an entry to the database associating a port on the second node over which the first node and the second node communicate with information indicative of one or more multicast groups.

43. The method of claim 40 wherein the management packet comprises a CGMP join message.

44. The method of claim 40 wherein the second node supports a plurality of IP Multicast extension protocols enhanced with respective authorization checks.
